(19) United States
(12) Patent Application Publication
(10) Pub. No.: US 2020/0189941 A1
(43) Pub. Date: Jun. 18, 2020

(54) Method and System for Treating Agricultural or Industrial Recirculation Water

(71) Applicant: Massachusetts Institute of Technology, Cambridge, MA (US)

(72) Inventors: Amit Kumar, Somerville, MA (US); John H. Lienhard, Lexington, MA (US); Kishor Govind Nayar, Cambridge, MA (US); Yvana Ahdab, Cambridge, MA (US)

(73) Assignee: Massachusetts Institute of Technology, Cambridge, MA (US)

(21) Appl. No.: 16/711,356

(22) Filed: Dec. 11, 2019

Related U.S. Application Data
(60) Provisional application No. 62/778,374, filed on Dec. 12, 2018.

(51) Int. Cl. C02F 1/469; C02F 1/44; C02F 1/66; C02F 1/52

(52) U.S. Cl. CPC C02F 1/4693; C02F 1/441; C02F 1/442; C02F 2101/163; C02F 1/66; C02F 1/5245; C02F 1/444

(57) ABSTRACT

Drainage water that includes anions and cations dissolved in water and that is received from an agricultural or industrial facility is treated by applying a voltage to an anode and a cathode on opposite sides of an electrically driven separation apparatus that further includes at least one monovalent-selective ion exchange membrane between the anode and the cathode. The drainage water is passed through the electrically driven separation apparatus, wherein monovalent ions are selected from the drainage water through the monovalent-selective ion exchange membrane. The drainage water is then recirculated as treated water through the facility after the monovalent ions are removed.

### RELATED APPLICATION

This application claims the benefit of U.S. Provisional Application No. 62/778,374, filed 12 Dec. 2018, the entire content of which is incorporated herein by reference.

### BACKGROUND

Water-treatment systems are used in a variety of contexts in agriculture and other applications. One such use is in greenhouses, which are discussed as an exemplary application in the text that follows, though water-treatment systems and methods for water treatment can also be used in field farming, golf-course grass management, mining water management, oil and gas water management, chloralkali industry water management, etc.

Currently, greenhouses typically use ‘reverse osmosis (RO)’ systems or ‘ion exchange’ systems to remove salt from source waters to produce ‘irrigation water’. They also use ‘cartridge filters’ and ‘media filters’ to remove particles in ‘source water’.

For treating recirculation water (in this context, water leaving a greenhouse that typically includes nitrates, sodium, calcium, and magnesium), greenhouses typically use ‘ultraviolet radiation’ based systems to disinfect the waters. An example of an existing water-treatment system 10 used with a high-tech greenhouse 26 is shown in FIG. 1, where source water 12 from a source 13 is pumped via pump 14 into a reverse-osmosis (RO) system 16, producing irrigation water 20 on the permeate side of the RO system 16. The irrigation water 20 is infused with nutrients 22 to produce nutrient water 24, which is fed into the greenhouse 26. A portion of drainage water 30 from the greenhouse 26 is recirculated as recirculation water 32 through an ultra-violet (UV) disinfection unit 28 and then injected back into the nutrient water 24 for recirculation through the greenhouse 26. Another portion of the drainage water 30 is discharged as discharge water 34 through a denitrification unit 36 before being sent to a discharge site 18 (e.g., an outwash field or aquifer).

U.S. Pat. No. 8,277,627 B2 discloses the use of ‘monovalent’ selective electrodialysis for the treatment of ‘source water’ to produce irrigation water. While solutions exist for treating ‘source water’ to generate ‘irrigation water’, no current solution is known for selectively removing sodium from ‘recirculation water’. Over time, sodium builds up in the greenhouse with recirculation of water and, eventually, once a threshold of typically 5-6 mmol/L of sodium is reached, all of the nutrient-rich ‘drainage water’ is discharged as ‘discharge water’. This leads to expenses arising from loss of nutrients and water and from the need to treat discharge water before disposal in select parts of the world.

### SUMMARY

Methods and apparatus for treating agricultural or industrial recirculation water are described herein, where various embodiments of the apparatus and method may include some or all of the elements, features and steps described below.

The apparatus and methods, referred to herein as electrically driven separation and apparatus/systems therefor, can be used to treat and tailor ion content in recirculation and drainage water used in hydroponic high-tech greenhouses and in other applications.

In a method for treating drainage water from an agricultural or industrial facility, drainage water that includes dissolved anions and cations is received from the facility; and a voltage is applied to an anode and a cathode on opposite sides of an electrically driven separation apparatus that further includes at least one monovalent-selective ion (cation or anion) exchange membrane between the anode and the cathode. The drainage water is passed through the electrically driven separation apparatus, and monovalent ions (cations or anions) are selectively removed from the drainage water through the monovalent-selective ion exchange membrane; and the drainage water is recirculated as recirculation water through the facility after monovalent ions are removed.

In some embodiments, electrically driven separation apparatus/systems can utilize an electrodialysis stack that combines conventional selective cation and anion electrodialysis (ED) membranes with monovalent-selective cation and anion membranes, ion specific sensors and a software control system. With these components, an electrically driven separation apparatus allows for removing sodium ions harmful for crops while retaining most of the beneficial ions, such as calcium, magnesium and nitrate. Electrically driven separation can increase the recirculation of drainage water in the greenhouses, saving greenhouse water, energy and fertilizer. Use of an electrically-driven-separation treatment system for ‘recirculation water’ can limit the build-up of sodium while retaining other beneficial ions and allow near 100% recirculation of ‘recirculation water’.

In particular embodiments, agricultural water is used with a total dissolved solids (TDS) level in a range from 300-10,000 ppm. The electrically driven separation apparatus can be operated in batch, semi-batch or continuous mode, depending on operating conditions. In the process, pre-dilution of drainage/recirculation water can be mixed with source water. In particular embodiments, a disinfection unit is positioned downstream from the electrically driven separation apparatus. In additional embodiments, a pressure-driven separation apparatus can is positioned upstream or downstream from the electrically driven separation apparatus. Further still, a pressure-driven separation apparatus, such as an apparatus for reverse osmosis or nanofiltration, can be used for pretreatment or post-treatment upstream or downstream from the electrically driven separation apparatus. In further embodiments, adjustments can be made to Ca and/or Mg and/or NO₃ concentration levels through various methods, such as but not limited to: pressure-driven separation and then mixing, addition of fertilizer, or precipitation using lime. Additionally, the pH of the water can be adjusted through various methods, such as, but not limited to, using bipolar ED membranes or via addition of acidic or basic solutions. Moreover, using a monovalent cation exchange membrane, for example, monovalent cationic species may be removed at 2× the removal rate for monovalent anionic species (i.e., sodium removal relative to nitrate removal); and monovalent cationic species may be removed at 2× the removal rate for divalent cationic species (i.e., sodium removal relative to calcium and/or magnesium removal). In other embodiments, the electrically driven separation methods and apparatus can be used in contexts other than agricultural, such as in oil and gas production, mining, and textile manufacturing, where different ions of interest can be selectively removed depending on the composition of the aqueous feed and the desired compositions of the output streams.

In particular embodiments, ion-specific sensors and a controller with software instructions stored on a computer-readable medium for processing readings from the sensors and adjusting operating parameters in response thereto can be included.

### BRIEF DESCRIPTION OF THE DRAWINGS

FIG. 1 is a schematic illustration showing a water treatment system 10 currently used in high-tech greenhouses.

FIG. 2 is a schematic illustration showing a first embodiment of an electrically driven separation system 38 for use, e.g., in high-tech greenhouses.

FIG. 3 is a schematic illustration showing a first embodiment of an electrically driven separation system 38 for, e.g., treating recirculation water.

FIG. 4 shows a configuration of membranes 48 and 52 in relation to an anode 56 and a cathode 54 in an electrically driven separation system 38.

FIG. 5 is a schematic illustration showing an electrically driven separation system 38 used for agricultural water reuse in a hydroponic greenhouse 26, where fertilizer 22 is added to the water.

FIG. 6 is a schematic illustration showing an electrically driven separation system 38 used in an open-field setting for agriculture water reuse.

FIG. 7 is a schematic illustration showing an electrically driven separation system 38 for use with a greenhouse 26 and for source water 12.

FIG. 8 is a schematic illustration showing electrically driven separation system 38 for use with an open field 26 and for source water 12.

FIG. 9 is a schematic illustration showing an electrically driven separation system 38 with a water splitter 66 for drainage/recirculation water 30.

FIG. 10 is a schematic illustration showing an electrically driven separation system 38 with a water splitter 66 for drainage/recirculation water 30 and with a mixer 42 for source water 12.

FIG. 11 is a schematic illustration showing an electrically driven separation system 38 with a water splitter 66 for drainage/recirculation water 30 and with an electrically driven separation system 38 for source water 12.

FIG. 12 is a schematic illustration showing an electrically driven separation system 38 with a water splitter 66 for treating drainage/recirculation water 30 and with an electrically driven separation system 38 and a mixer 42 for treating source water 12.

FIG. 13 is a schematic illustration showing an electrically driven separation system 38 for use with a greenhouse 26 and with pre-dilution of drainage/recirculation water 30 with source water 12.

FIG. 14 is a schematic illustration showing an electrically driven separation system 38 for use with a greenhouse 26 and with an ultra-violet (UV) disinfection unit 28 in a drainage/recirculation loop.

FIG. 15 schematically shows the use of an electrically driven separation apparatus 38 at a generic facility.

FIG. 16 schematically illustrates adjustment of pH through the use of a bipolar (BP) electrodialysis (ED) membrane 51. Sodium hydroxide is recirculated along one side of the BP membrane 51 while, on the other side, hydroxyl ions are generated.

FIG. 17 schematically shows, at the system level, an electrically driven separation system 38 with the BP membrane. The system has an additional sodium hydroxide (NaOH) loop 88 to help generate hydroxyl ions to maintain pH.

FIG. 18 schematically shows a system that can adjust pH through the use of bipolar (BP) ED membranes. Sodium hydroxide is recirculated along one side of a BP membrane, while, on the other side, hydroxyl ions are generated. Selective ion removal can be performed along with maintenance of pH.

FIG. 19 shows a single water treatment system being used by multiple facilities 26.

FIG. 20 is a schematic illustration showing an embodiment of an electrically driven separation system 38 for use in an oil and gas application.

FIG. 21 is a schematic illustration showing an embodiment of an electrically driven separation system 38 for use in a textile dyeing application.

FIG. 22 is a schematic illustration showing an embodiment of an electrically driven separation system 38 for use in the chloralkali industry.

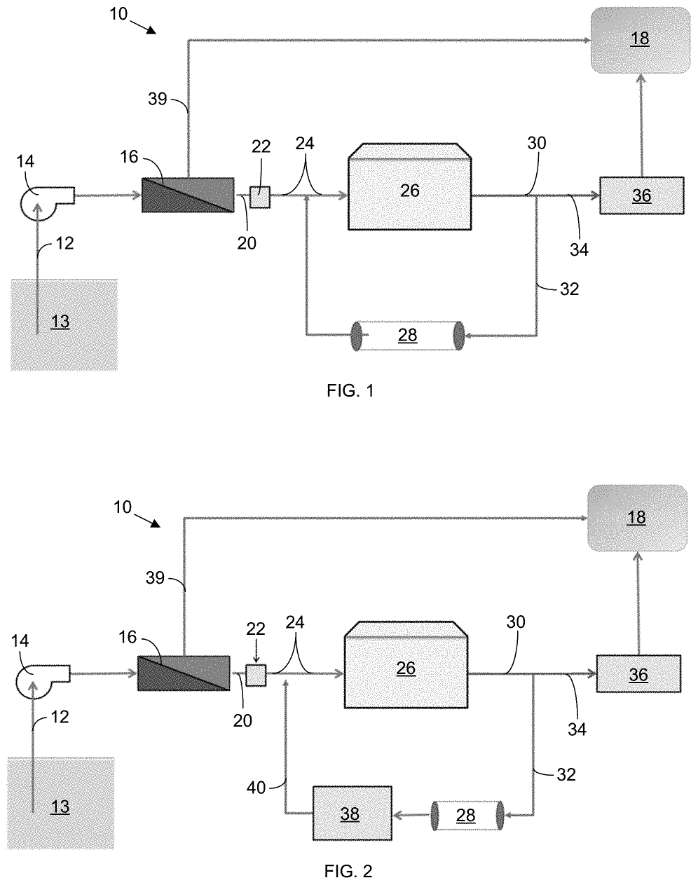

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa or about 90-110 kPa) and temperature (e.g., −20 to 50° C. or about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” means within ±10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

An electrically driven separation apparatus can be used to treat ‘recirculation water’ or ‘drainage water’ in greenhouses to save water, energy and fertilizer in a greenhouse.

The different water types typically found in a greenhouse (references made herein to “greenhouses” also include hothouses) can be defined as follows in this context (and can be defined similarly for other types of agriculture or agricultural facilities, including open-air farming, aquaculture, or any other means for growing plants—all of which are included within the scope of references made herein to “agriculture” or “agricultural facilities”); and analogous aqueous compositions can be found in other industrial applications to which these systems and methods can be applied:
“source water”: water coming from a source (e.g., municipal water, river water, groundwater or seawater);
“irrigation water”: the pure water that will be going to the greenhouse (or to an agricultural facility)—practically, this means source water that is ‘treated’ to remove impurities;
“nutrient water”: nutrients (i.e., fertilizers) are added to the irrigation water to obtain ‘nutrient water’; this nutrient water is rich in nitrate, calcium and magnesium and is the source of nutrition for plants in a hydroponic greenhouse;
“drainage water”: water leaving an agricultural facility is called ‘drainage water’; in particular embodiments, this water can still have a high nitrate content and can contain a high amount of sodium; a high concentration of nitrate ions in drainage water can make treatment difficult using conventional approaches; in exemplary embodiments, the drainage water becomes either ‘recirculation water’ or ‘discharge water’;
“recirculation water”: drainage water rich in nutrients is recirculated in greenhouses to save water and fertilizer; what limits the amount of recirculation is sodium levels in the water;
“discharge water”: drainage water may either be directly discharged without recirculation or may be recirculated as recirculation water and discharged once it reaches a sodium threshold level (around 5-6 mmol/L); both of these water streams are defined as discharge water;
“treated water”: this is the useful treated water generated by the electrically driven separation apparatus that is rich in nutrients but low in sodium;
“sodium absorption ratio (SAR)”: SAR is a measure of the amount of sodium in water relative to the amount of calcium and magnesium and can be calculated as follows:

$$SAR = \frac{[ {Na}^{+} ]}{\sqrt{[ {Ca}^{2 +} ] + [ {Mg}^{2 +} ]}} ;$$

“adjusted sodium absorption ratio (SAR_{1/2})”: SAR_{1/2} is another measure of the amount of sodium in water relative to the amount of calcium and magnesium and can be expressed as follows:

$${SAR}_{1 / 2} = \frac{[ {Na}^{+} ]}{\sqrt{\frac{[ {Ca}^{2 +} ] + [ {Mg}^{2 +} ]}{2}}} ;$$

“nitrate-adjusted SAR (N-SAR): N-SAR is a measure we have defined to characterize electrically driven separation apparatus' ability to remove sodium while limiting the removal of calcium, magnesium and nitrate ions and can be expressed as follows:

$$N - SAR = \frac{[ {Na}^{+} ]}{\sqrt{\frac{[ {Ca}^{2 +} ] + [ {Mg}^{2 +} ] + [ {NO}_{3}^{1 -} ]}{3}}} .$$

An embodiment of an electrically driven separation apparatus 38 treating recirculation water 32 is shown in FIG. 2, where source water 12 from a source 13 (e.g., an open body of water or a closed reservoir) is pumped by a pump 14 through a conduit (each of the indications of fluid flow throughout this disclosure are to be understood as being through one or more conduits joining the described parts) to a reverse-osmosis system 16 that separates a retentate 39 from a permeate 20, which is referred to, in this embodiment, as “irrigation water.” Additives 22 (in this case, nutrients) are added to the irrigation water 20 to produce a chemical-dosed liquid 24 (referred to here as “nutrient water”) that is then fed to the agricultural facility 26, where it is fed to the crops being grown therein.

As shown in FIG. 2, post-use water 30 (e.g., “drainage water”, including “recirculation water”) leaves the point of use 26—in this case, the agriculture facility (e.g., a greenhouse, though the term, “facility,” as used herein, includes both man-made structures as well as natural bodies, such as open farm land). A portion of this aqueous composition 30 is recirculated as recirculation water 32, which is passed through an ultra-violet (UV) disinfection unit 28 and then treated by an electrically driven separation apparatus 38 that includes at least one monovalent-selective cation-exchange membrane to provide an aqueous composition low in sodium, while retaining nitrates, calcium, and magnesium. The composition of the water can be characterized by metrics, such as sodium absorption ratio (SAR), total dissolved solids (TDS), and nitrate-adjusted SAR (N-SAR).

The remaining portion of the aqueous composition 30 that is not recirculated is passed, as discharge water 34, through a denitrification unit 36 and then to a discharge site 18. The retentate 39 from the RO system 16 is also sent to the discharge site 18.

An embodiment of the electrically driven separation apparatus 38 is shown in FIG. 3. In this embodiment, source water 12 is infused in a mixer 42 with fertilizer 22 to produce nutrient water 24, which is then fed to a point of use 26 in the form of a greenhouse or other agricultural facility. The water then leaves the agriculture facility 26 as ‘drainage water’ 30, including ‘recirculation water’ with an SAR value <10, an N-SAR value of 1-3, and a TDS <10,000 ppm.

The drainage water 30 is treated by an electrically driven separation apparatus 38 that includes at least one monovalent-selective cation exchange membrane to produce treated water 40 low in sodium while retaining nitrates, calcium and magnesium in the treated water 40, wherein the treated water 40 has an N-SAR value of 0.1-0.6 and a SAR value <2. Optionally, the quality of water can be controlled by the presence of one or more sensors 44 (such as, but not limited to, the use of sensors to sense the composition of the water or the use of sensors to detect the conductivity or the pH of the water) and controllers 46 (controlling operation of the electrically driven separation apparatus and adjusting parameters, such as but not limited to current, voltage, flow velocity). In addition to the treated water 40, The electrically driven separation apparatus 38 produces discharge water rich in sodium, which is discharged to a discharge site 18.

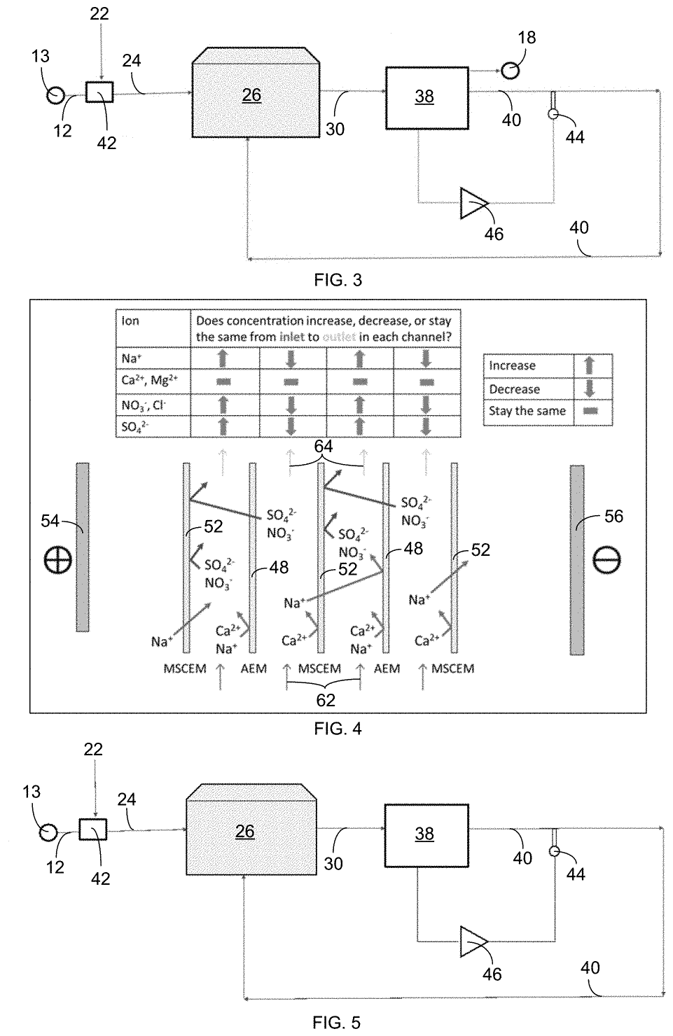

One embodiment of the system includes a plurality of alternating membranes: a monovalent-selective cation exchange membrane (MSCEM) 52, followed by a regular anion exchange membrane (AEM) 48 (see FIG. 4). Inlet water 62, including Na, Ca, Mg, Cl, NO₃, and SO₄ ions, is fed through this system, where ions with the same charge will have the same transport trajectory. Consequently, only one ion of each charge group is shown in the diagrams for simplicity. As the name suggests, MSCEMs 52 allow only monovalent cations across, while AEMs 48 allow only anions across. Feed water that is rich in many ions flows in and, within the diluate channel (the second channel from left in FIG. 4), the concentration of sodium and all anions is reduced, while the calcium and magnesium concentration is held nearly the same (or subject to very small reductions). Meanwhile, the concentrate channel (the first channel from left in FIG. 4) sees an increase in the concentration of sodium and anions, while the calcium and magnesium concentrations are held the same. Flow through the diluate channel is combined in a header to give the useful product output of treated water 40.

A survey of a sample of actual greenhouses and an identification of their water compositions and assessed ideal target feedwater compositions is reported in Table 1, below.

TABLE 1
Typical water compositions
of feed water, source water and drainage water

| Water source | Type of water | SAR | SAR_{1/2} | N-SAR |
|---|---|---|---|---|
| Greenhouse 1 | drainage | 0.42 | 0.60 | 0.36 |
| Greenhouse 1 | feed water | 0.32 | 0.45 | 0.27 |
| Greenhouse 2 | feed water | 0.25 | 0.35 | |
| Greenhouse 3 | feed water | 1.80 | 2.55 | 1.97 |
| Greenhouse 4 | feed water | 0.29 | 0.42 | |
| Lab simulation 1 | source water | 3.22 | 4.55 | |
| Lab simulation 2 | source water | 2.79 | 3.94 | |
| Greenhouse 1 | source water | 1.47 | 2.08 | 2.18 |
| Greenhouse 2 | source water | 1.82 | 2.57 | 3.04 |
| Greenhouse 4 | source water | 1.12 | 1.58 | |
| Seawater- | seawater | 57.01 | 80.62 | |
| characteristic | | | | |

One major application for this technology is for use in hydroponic greenhouses. We have defined a factor, nitrate-adjusted SAR (N-SAR), to characterize this technology's performance. In the context of a hydroponic greenhouse, the system can reduce N-SAR values from an SAR value <10 and/or an N-SAR value of 1-3 and a TDS <10,000 ppm to water with an N-SAR value of 0.1-0.6 and an SAR value <2 (an advantageous sub-range is 0.2-0.5 for the final SAR). The sub-10,000-ppm TDS value is characteristic of greenhouses and orchards, while a TDS <35,000 ppm can be achieved for seawater treatment, and a TDS <200,000 ppm can be achieved for brine treatment; meanwhile, the low SAR value may not be needed when the system is used in contexts other than in greenhouses. In other embodiments, the method and system can be used in an industrial setting for selective ion removal from, e.g., water used in oil and gas extraction, in mining, or in textile manufacturing.

Maintaining sodium levels around 5-6 mmol/L can save greenhouses an estimated 10-30% of their nutrient budget due to higher recirculation. Nutrient expenses are typically around US $3/m². For a 50-hectare operation, the savings can be US $500,000 annually.

The electrically driven separation apparatus can be used to treat ‘recirculation water’ or ‘drainage water’ from any facility that has a water treatment configuration and requirements that are similar to those of greenhouses with the usefulness of the electrically driven separation apparatus being in the form of savings in water, energy and chemical use, and benefits in terms of cost savings.

Broader definitions of the water streams are given below:
“source water”: water coming from a source (e.g., municipal water, river water, groundwater or seawater);
“treated source water,” which is analogous to “irrigation water”: the source water that is ‘treated’ to remove impurities (through media filtration or reverse osmosis or nanofiltration, etc.) before water is sent to facility for use;
“chemical dosed water,” which is analogous to “nutrient water”: chemicals or/and salts are added to the treated source water to produce ‘chemical dosed water’; this chemical dosed water is rich in salts (such as, but not limited to, sodium, chloride, calcium, magnesium, nitrate etc.) needed for use in the facility; for a textile dyeing facility, chemicals and salts added include sodium-chloride-based dyes, which allow clothes to be dyed in the facility; for an oil and gas drilling facility, “chemical dosed water” would be “fracking fluid” or “injection fluid” injected into oil wells for recovery of oil; for the electrolyzer in a chlor-alkali plant producing chlorine and sodium hydroxide, “chemical dosed water” will involve addition of very pure sodium chloride salts to highly pure treated source water;
“drainage water”: “chemical dosed water,” after being used in the facility, leaves the facility with its composition changed as ‘drainage water’;
   in particular embodiments, this water can still have a high amount of recoverable useful monovalent anions (such as nitrates in greenhouses) and high amounts of undesired monovalent cations (such as sodium in greenhouses); while facilities desire the reuse of drainage water as ‘recirculation water’ to maximize the recover useful monovalent anions, the presence of undesired monovalent cations can inhibit the direct reuse of “drainage water”; furthermore a high concentration of monovalent anions in drainage water can make treatment difficult using conventional approaches;
   in particular embodiments, the monovalent cations are useful and desirable to recover while one or more monovalent anions are undesired;
   in particular embodiments, the monovalent ions may be useful and desirable to recover, while the divalent or trivalent or polyvalent ions are undesired;
   in exemplary embodiments, the drainage water becomes either ‘recirculation water’ or ‘discharge water’;
   in exemplary embodiments, the divalent ions may be useful and desirable to recover, while the monovalent ions are undesired;
“recirculation water”: drainage water rich in chemicals and salts is recirculated in the facility to save water and chemicals; what limits the amount of recirculation is the levels of monovalent cations or anions in the water (in greenhouses, sodium levels limit recirculation; in textile dyeing, the presence of divalent ions limits recirculation; in certain oil and gas fields, both sodium and chloride levels limit recirculation; in the electrolyzer in chlor-alkali plants, the sodium and chloride levels are too low to allow direct recirculation).
“discharge water”: drainage water may either be directly discharged without recirculation or may be recirculated as recirculation water and discharged once it reaches a threshold level in a key ion (for greenhouses, sodium thresholds are around 5-6 mmol/L); both of these water streams are defined as discharge water;
“treated drainage water”: this is the useful treated drainage water generated by the electrically driven separation system that is rich in useful ions but low in undesired ions;
   for greenhouses, the treated drainage water is low in sodium but rich in nitrates;
   for textile dyeing, the treated drainage water can be high in sodium chloride concentration but low in divalent ions and other chemicals;
   for oil and gas applications, the treated “produced water” from an oil well can have monovalent ions within a specific range and divalent ions within another specific range;
   for electrolyzers in chloralkali production, treated drainage water can be saturated in sodium chloride with the concentration of polyvalent impurities reduced;
“pre-treated drainage water”: drainage water prior to treatment by electrically driven separation system may need to be pre-treated through the use of any of the following: media filters, flocculation, oil-water separators, nanofiltration, ultraviolet water treatment, etc., for the removal of particulates, chemical or biological contaminants;
“post-treated drainage water”: treated drainage water from the electrically driven separation apparatus may need to be further post-treated through the use of any of: nanofiltration, ultraviolet water treatment, ozone treatment, flocculation, etc., for the removal of chemical or biological contaminants.

Table 2, below, highlights some of the applications of the electrically driven separation apparatus.

TABLE 2
Various potential applications for electrically driven separation
apparatus/system

| Generic | | | | Chloralkali |
|---|---|---|---|---|
| definition | Agriculture | Oil and gas | Textile dyeing | production |
| Facility | Greenhouse, | Oil well | Dyeing unit | Electrolyzer |
| | open fields | | | plant |
| Usefulness | Reduce | Reduce | Increase | Increasing |
| of | sodium | sodium | monovalent | sodium |
| electrically | concen- | chloride in | ion concentra- | chloride |
| driven | tration | produced | tion while | concentration; |
| separation | in drainage | water; | reducing or | saving salt |
| apparatus | water while | saving | limiting | usage and |
| | retaining | overall | divalent ions; | production |
| | nitrates; | costs | saving overall | costs |
| | saving | | dyeing costs | |
| | fertilizer | | | |
| | costs | | | |
| Source | Source | Source | Source water | Source water |
| water | water | water | | |
| Treated | Irrigation | Treated | Treated source | Treated source |
| source | water | source | water or | water |
| water | | water | Softened water | |
| Chemical | Nutrient | Fracking | Water with | Saturated brine |
| dosed | water | fluid or | dye and | (TDS: 260,000 |
| water | | injection | sodium | ppm of NaCl) |
| | | water | chloride | |
| Drainage | Drainage | Produced | Water with | Depleted brine |
| water | water (TDS: | water | dye and | (TDS: ~200,000 |
| | 600-1500 | (TDS: | sodium | ppm of NaCl) |
| | ppm, SAR: | 20,000- | chloride | |
| | 0.5-2.5, | 70,000 | (TDS: 7000 | |
| | N-SAR: | ppm) | ppm) | |
| | 1.25-3) | | | |
| Recircula- | Re- | Treated | NA: no direct | Depleted brine |
| tion water | circulation | produced | recirculation; | (TDS: ~200,000 |
| | water | water | requires | ppm) |
| | | | treatment | |
| | | | before | |
| | | | recirculation | |
| Discharge | Discharge | Produced | Discharge | Discharge |
| water | water | water to | typically not | water (TDS: |
| | | discharge | allowed | <200,000 ppm) |
| | | well (high | | |
| | | TDS) | | |
| Treated | Treated | Treated | Recirculation | Saturated brine |
| drainage | drainage | drainage | water for dye- | (TDS: 260,000 |
| water | water | water (re- | ing (increased | ppm, replen- |
| | (SAR: | duced | sodium levels, | ished in sodium |
| | 0.1-0.5, | sodium | retaining most | chloride, free of |
| | N-SAR: | levels, | of divalent | divalent ions) |
| | 1.25-3) | retaining | ions) | |
| | | most of | | |
| | | divalent | | |
| | | ions) | | |

Additionally, the electrically driven separation apparatus and methods described herein can be used for applications in the mining industry, where the point of use/facility is a mine, and where the drainage/discharge water is either tailings discharge or solution-mined brine. In a particular exemplification, the system can be used for lithium mining. Additional embodiments of the system are shown in FIGS. 5-23.

The electrically driven separation system 38 schematically shown in FIG. 5 is used for agricultural water reuse in a hydroponic greenhouse 26, where fertilizer 22 is added to the water. The electrically driven separation system 38 produces treated water 40 that is rich in nutrients but low in sodium. The treated water 40 is recirculated from the electrically driven separation system 38 to the hydroponic greenhouse 40 for reuse in feeding crops grown therein.

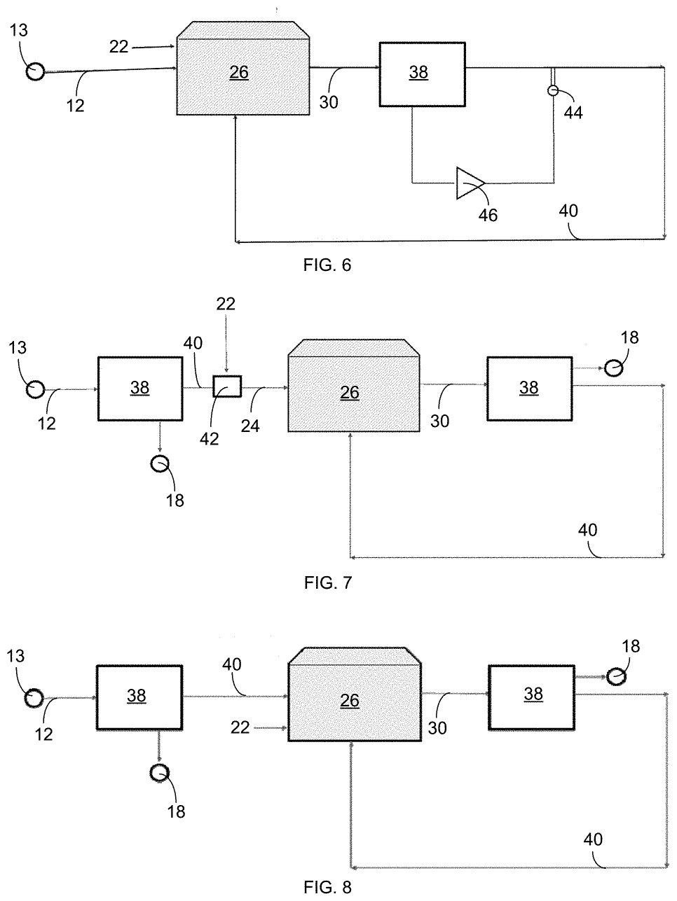

A schematic illustration showing an electrically driven separation system 38 used in an open-field setting for agriculture water reuse is shown in FIG. 6. This system is similar to that shown in FIG. 5, except the fertilizer 22 is added directly to the field 26 in this application instead of being added to the source water 12 via the mixer, as in FIG. 5.

A configuration wherein electrically driven separation systems 38 are provided both for use with a greenhouse 26 (at right) and for use with the source water 12 (at left) is schematically shown in FIG. 7.

A configuration wherein electrically driven separation systems 38 are provided both for use with an open field 26 (at right) and for use with the source water 12 (at left) is schematically shown in FIG. 8.

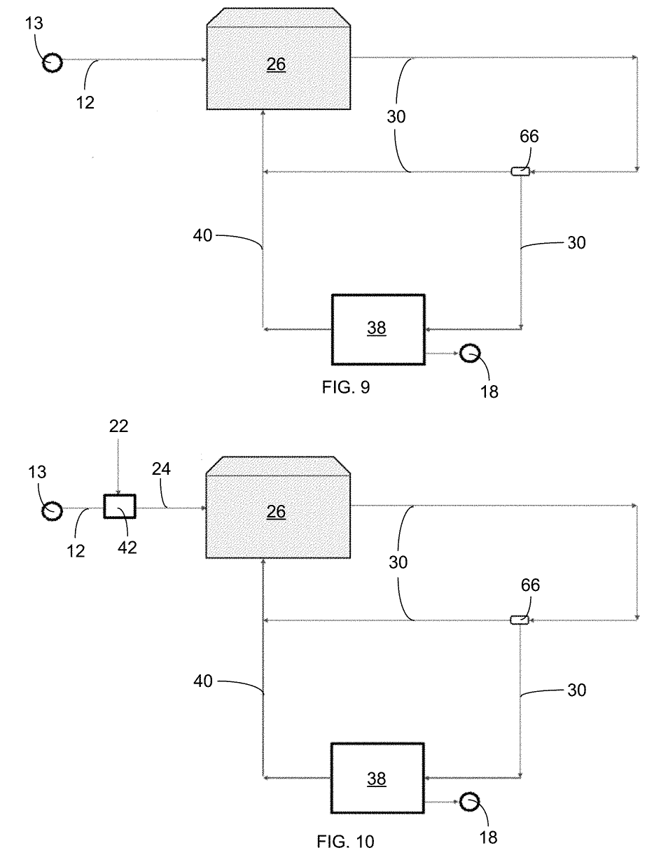

A schematic illustration showing an electrically driven separation system 38 with a water splitter 66 for drainage water 30 is shown in FIG. 9, where drainage water 30 is mixed with treated water 40 from the electrically driven separation system 38 before being fed back to the point of use 26.

A schematic illustration is provided in FIG. 10 that is similar to that of FIG. 9, showing an electrically driven separation system 38 with a water splitter 66 for drainage/recirculation water 30, but, in this case, with a mixer 42 for adding fertilizer 22 to the source water 12.

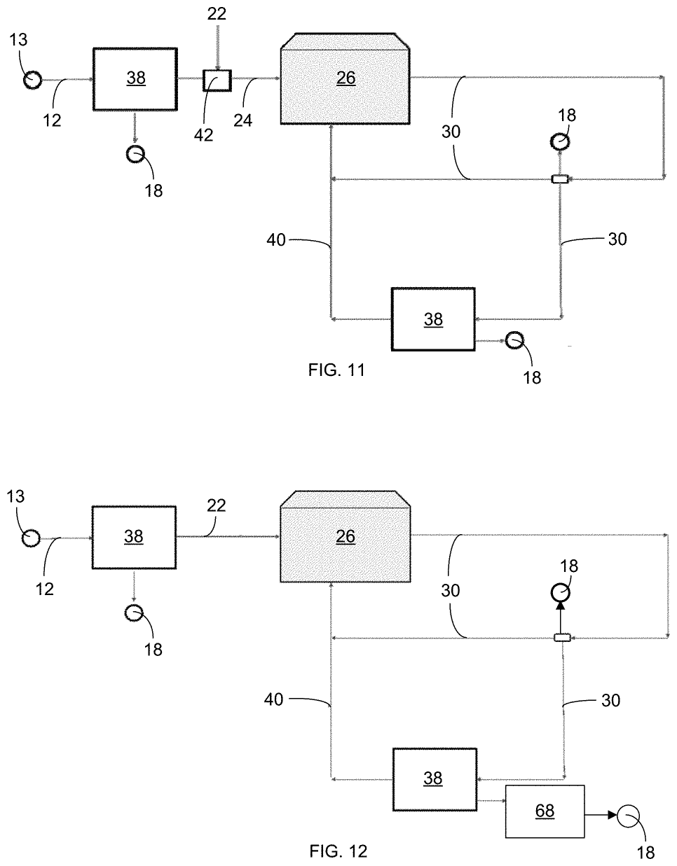

The electrically driven separation system 38 schematically illustrated in FIG. 11 is configured with a mixer 42 upstream from the electrically driven separation system 38, with a water splitter 66 for drainage/recirculation water 30, and with a first electrically driven separation system 38 configured and positioned to treat the source water 12, while a second electrically driven separation system 38 is configured and positioned to receive one of two flow streams exiting the water splitter 66.

Another electrically driven separation system 38 with a water splitter 66 for splitting the flow of drainage/recirculation water 30 and with electrically driven separation systems 38 both for treating source water 12 and for treating a split portion of the drainage/recirculation water 30 is schematically shown in FIG. 12. The electrically driven separation system 38 in this exemplification outputs its concentrated product to a mineral recover unit 48 to recover minerals therefrom.

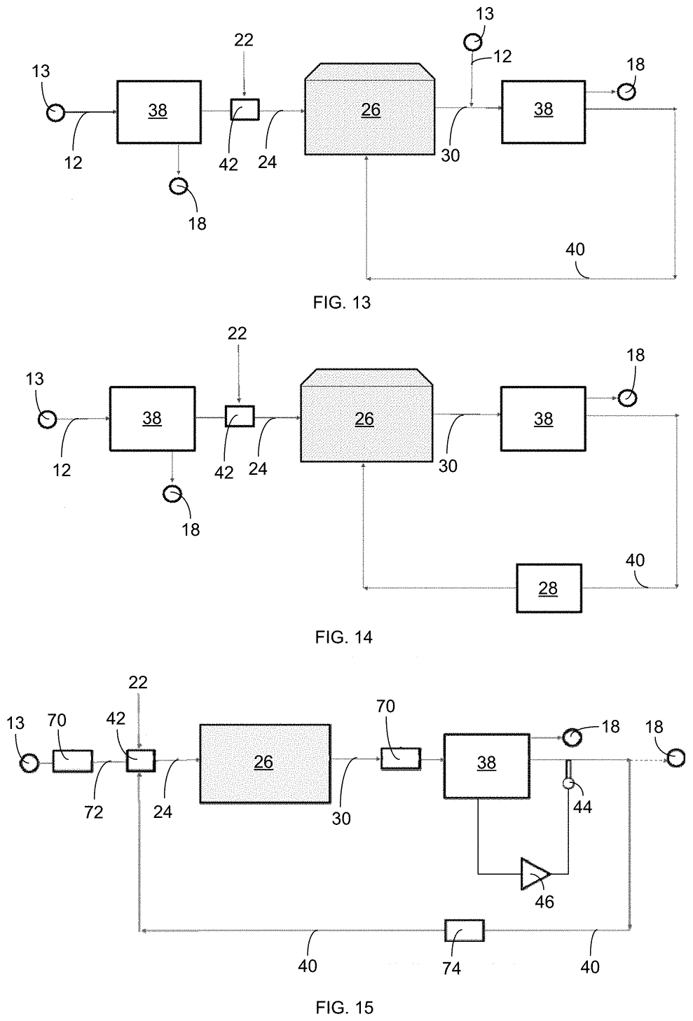

A schematic illustration showing a pair of electrically driven separation systems 38 for use with a greenhouse 26 and with pre-dilution of drainage/recirculation water 30 with additional source water 12 before being fed through the second electrically driven separation system 38 is provided in FIG. 13. In this exemplification, fertilizer 22 is added via the mixer 42 to produce nutrient water 24 that is fed to the agricultural point of use 26.

An electrically driven separation system 38 for use with a greenhouse 26 and with an ultra-violet (UV) disinfection unit 28 for disinfecting the treated water 40 in a drainage/recirculation loop is schematically shown in FIG. 14.

The use of an electrically driven separation apparatus 38 at a generic facility is schematically shown in FIG. 15, wherein the source water is first passed through a pre-treatment system 70 (including, e.g., a sand filter, a cartridge filter, a bag filter, an ultrafiltration or nanofiltration unit, an ion exchange system, and/or an absorbent bed, e.g., for lithium mining) to produce treated source water 72, and chemicals 22 [e.g., when used for agricultural applications—calcium nitrate, ammonium phosphate (or other phosphate), potassium nitrate, and/or an iron chelate; and, when used for oil and gas production, polymers, anti-scalents, etc.] are added to the treated source water 22 at the mixer 42. Another pre-treatment system 70 (including, e.g., a filter, ion exchange system, etc., as described above) treats the post-use (drainage) water 30 before it is passed through the electrically driven separation system 38. A sensor 44 is provided downstream of the electrically driven separation system 38 to detect the ion composition of the treated water 40. The treated water 40 is then passed through a post-treatment system 74 [e.g., an ultraviolet-radiation treatment system when used for an agricultural (e.g., greenhouse) application] before being recirculated back to the mixer 24 where it is mixed with the treated source water 72 before being fed into the point of use 26.

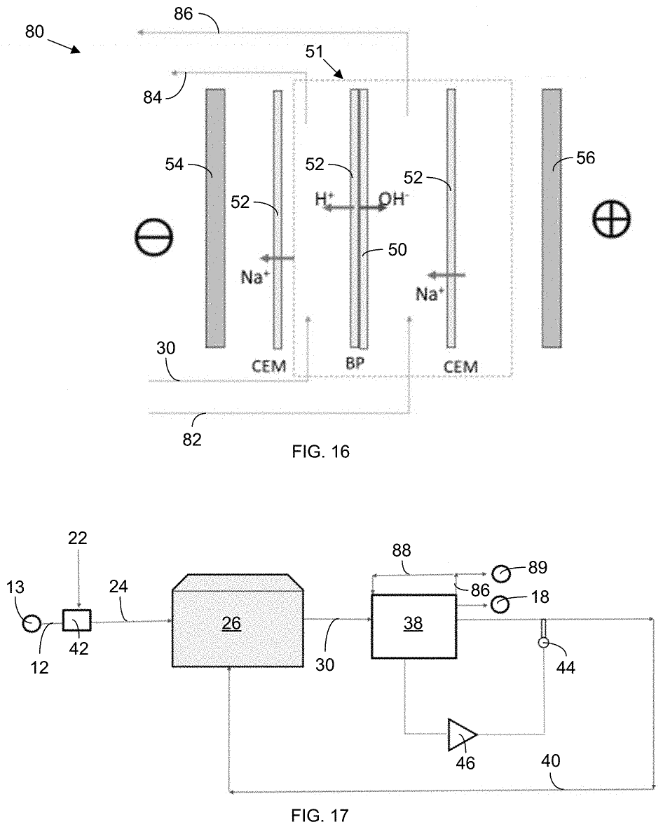

Adjustment of the pH of drainage/recirculation water 30 in an electrically driven separation system through the use of a bipolar (BP) electrodialysis (ED) membrane 51 (comprising a cation exchange membrane 52 joined with an anion exchange membrane 50) is schematically shown in FIG. 16. The BP membrane 51 is bounded by cation exchange membranes 52 on each side in a repeating unit (with repeat units not shown) between an anode 54 and a cathode 56 in a containment vessel. Sodium hydroxide is recirculated along one side of the BP membrane 51 while, on the other side, hydroxyl ions are generated. Selective ion removal can thereby be achieved along with maintenance of pH.

An electrically driven separation system 38 containing the BP membrane 51 of FIG. 16 is schematically shown in FIG. 17. The system has an additional sodium hydroxide (NaOH) loop 88 for the concentrated NaOH output 86 to help generate the hydroxyl ions to maintain pH. The NaOH loop 88 also includes an NaOH discharge 89. This system can be used in any facility where monovalent ions are to be selectively removed and where pH is to be maintained.

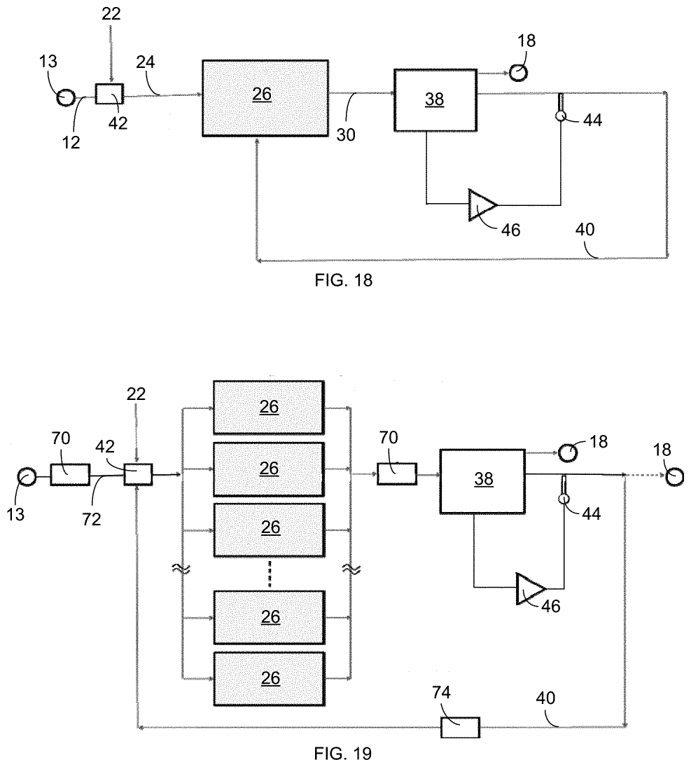

An additional use of an electrically driven separation apparatus 38 at a generic facility is schematically shown in FIG. 18. This system is similar to that of FIG. 15 but omits the pre- and post-treatment systems 70 and 74.

A single water-treatment system being used by multiple facilities 26 in parallel is schematically shown in FIG. 19. Source water from source 13 is fed through a pre-treatment system 70 to produce treated source water 72, which is then fed to a mixer 42 where chemicals 22 are added before splitting the flow to each of multiples points of use 26. The drainage water exiting the points of use 26 are then joined and fed through the second pre-treatment system 70 before being fed to the electrically driven separation apparatus 38.

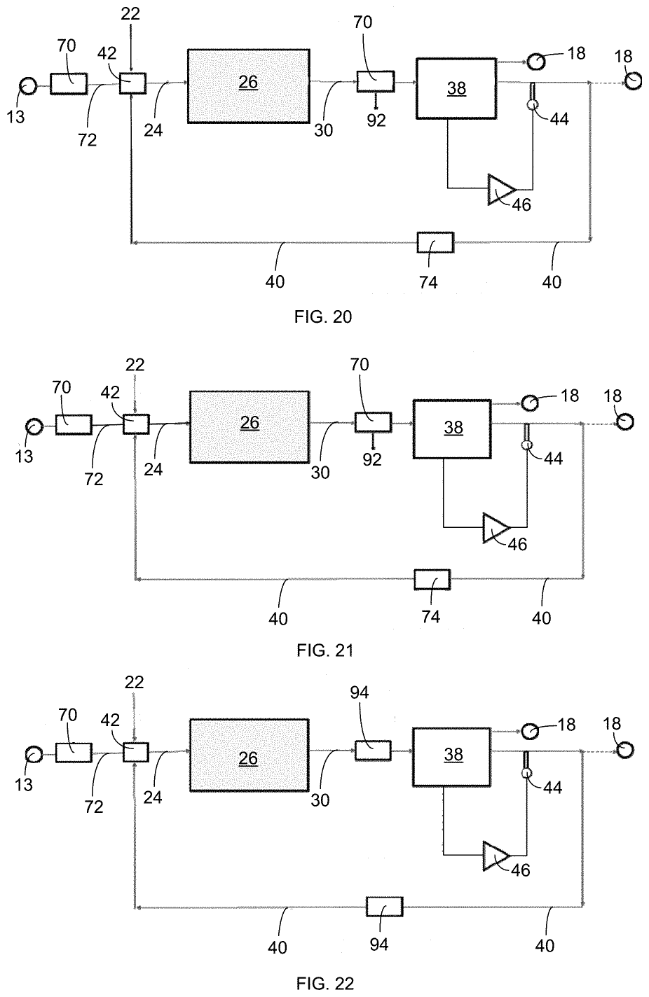

An electrically driven separation system 38 for use in an oil and gas application is schematically shown in FIG. 20. In applications where the point of use 26 is an oil and/or gas well, chemicals 22 added can include (a) an acid (e.g., hydrochloric acid) for dissolving minerals and initiating cracks in rock; (b) a biocide (e.g., glutaraldehydehyde, quaternary ammonium chloride, or tetrakis hydromethyl-phosphonium sulfate) for eliminating bacteria; (c) a breaker (e.g., ammonium persulfate, sodium chloride, magnesium peroxide, magnesium oxide, or calcium chloride) that acts as a product stabilizer or that allows delayed break down of a gel; (d) a clay stabilizer (e.g., choline chloride, tetramethyl ammonium chloride, or sodium chloride); (e) a corrosion inhibitor (e.g., isopropanol, methanol, formic acid, acetaldehyde); (f) a crosslinker (e.g., petroleum distillate, potassium metaborate, triethanolamine zirconate, sodium tetraborate, boric acid, a zirconium complex, a borate salt, ethylene glycol, or methanol); (g) a friction reducer (e.g., polyacrylamide, petroleum distillate, methanol, or ethylene glycol); (h) a gelling agent (e.g., guar gum, petroleum distillate, methanol, a polysaccharide blend, or ethylene glycol); (i) an iron control agent (e.g., citric acid, acetic acid, thioglycolic acid, or sodium erythorbate) that prevents precipitation of metal oxides; (j) a non-emulsifier (e.g., lauryl sulfate, isopropanol, or ethylene glycol); (k) a pH-adjusting agent (e.g., sodium hydroxide, potassium hydroxide, acetic acid, sodium carbonate, or potassium carbonate); (l) a scale inhibitor (e.g., a copolymer of acrylamide and sodium acrylate, sodium polycarboxylate, or phosphonic acid salt); and/or a surfactant (e.g., lauryl sulfate, ethanol, naphthalene, methanol, isopropyl alcohol, or 2-butoxyethanol).

The pre-treatment system 70 can include an oil-removal system and/or a total suspended solids (TSS) removal system, which can include a clarifier, a bag filter, an ion-exchange ultrafiltration system, and a nanofiltration system. Meanwhile, the post-treatment system 74 can include a nanofiltration system for sulfate removal.

A schematic illustration showing an embodiment of an electrically driven separation system 38 for use in a textile dyeing application, where divalent ions are removed and where monovalent ions are concentrated in the treated product, is provided in FIG. 21. In this exemplification, the point of use facility 26 is a textile dyeing unit, and the additives 22 added at the mixer 42 can include salts and dyes, producing “dyewater” with a TDS of 30,000-120,000 parts per million (ppm). The drainage (effluent) water from the textile dyeing unit 26 can have a TDS of 7,000 ppm, a chemical oxygen demand (COD) of 750 ppm, and a biochemical oxygen demand (BOD) of 500 ppm. Meanwhile, the treated water 40 leaving the electrically driven separation system 38 can have a TDS of 30,000-120,000 ppm and have a high content of monovalent ions and a low content of polyvalent ions. The pre-treatment and system 70 can include pretreatment systems common to all applications (including those discussed above), such as for clarification (if water is cloudy/muddy), sand filtration, and/or bag filters, as well as pretreatment systems that may be particularly advantageous in the context of textile dyeing, such as ultrafiltration and nanofiltration. Meanwhile, in the context of textile dyeing, the post-treatment system 74 can include a nanofiltration system.

An electrically driven separation system 38 for use in the chloralkali industry, where monovalent ions are concentrated for recirculation, is schematically illustrated in FIG. 22. In this case, the additive 22 added in the mixer 42 can be salt (NaCl), producing a saturated brine with a TDS of, e.g., 260,000 ppm that is then fed to an electrolyzer 26, acting as the point of use, which produces chloralkali, Cl₂, and NaOH. The drainage water 30 from the electrolyzer 26 is a depleted brine with a TDS of 200,000 ppm, which is then passed through a heat exchanger 94 that cools the depleted brine 30. The depleted brine 30 is then fed to the electrically driven separation apparatus 38. The treated brine 40 produced by the electrically driven separation apparatus 38 is passed through another heat exchanger 94 that reheats the treated brine 40 as it is recirculated back to the mixer 42 for reinjection into treated source water 72.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for treating drainage water from an agricultural or industrial facility, comprising:
receiving the drainage water from the facility, wherein the drainage water includes anions and cations dissolved in water;
applying a voltage to an anode and a cathode on opposite sides of an electrically driven separation apparatus that further includes at least one monovalent-selective ion exchange membrane between the anode and the cathode;
passing the drainage water through the electrically driven separation apparatus;
selectively removing monovalent ions from the drainage water through the monovalent-selective ion exchange membrane; and
recirculating the drainage water as treated water through the facility after the monovalent ions are removed.

2. The method of claim 1, wherein the drainage water comprises sodium ions, wherein sodium ions are substantially removed by the monovalent-selective ion exchange membrane.

3. The method of claim 2, wherein the drainage water further comprises at least one of calcium cations, magnesium cations, nitrate anions, chloride anions, and sulfate anions.

4. The method of claim 1, wherein the facility is a greenhouse.

5. The method of claim 1, wherein the at least one monovalent-selective ion exchange membrane comprises at least one monovalent-selective cation exchange membrane.

6. The method of claim 5, wherein the electrically driven separation apparatus further includes at least one anion exchange membrane between the anode and the cathode.

7. The method of claim 6, further comprising a plurality of the monovalent-selective cation exchange membranes and anion exchange membranes aligned in parallel between the anode and the cathode.

8. The method of claim 1, further comprising at least one bipolar electrodialysis membrane aligned in parallel between the anode and the cathode.

9. The method of claim 1, wherein the facility is an agricultural facility.

10. The method of claim 1, wherein the drainage water received from the facility has a sodium absorption ratio <10.

11. The method of claim 1, wherein the drainage water received from the facility has a nitrate-adjusted sodium absorption ratio in a range from 1-3.

12. The method of claim 1, wherein the drainage water received from the facility has a total dissolved solids content <220,000 ppm.

13. The method of claim 1, wherein the drainage water received from the facility has a total dissolved solids content <90,000 ppm.

14. The method of claim 1, wherein the drainage water received from the facility has a total dissolved solids content <10,000 ppm.

15. The method of claim 12, wherein the drainage water received from the facility has a total dissolved solids content of at least 100 ppm.

16. The method of claim 12, wherein the drainage water received from the facility has a total dissolved solids content of at least 300 ppm.

17. The method of claim 1, wherein the drainage water has a nitrate-adjusted sodium absorption ratio in a range from 0.1-0.6 after monovalent ions are removed through the monovalent-selective ion exchange membrane.

18. The method of claim 1, wherein the drainage has a sodium absorption ratio <2 after monovalent ions are removed through the monovalent-selective ion exchange membrane.

19. The method of claim 1, further comprising using at least one sensor to detect the composition of the drainage water and operating a controller in response to sensor detections to control operating parameters of the electrically driven separation apparatus, wherein the controlled operating parameters include at least one of electric current to at least one of the anode and the cathode, voltage applied to at least one of the anode and the cathode, and flow velocity of the drainage water through the electrically driven separation apparatus.

20. The method of claim 1, further comprising diluting the drainage water with water from a source before passing the drainage water through the electrically driven separation apparatus.

21. The method of claim 1, further comprising disinfecting the treated water with a disinfection unit downstream from the electrically driven separation apparatus.

22. The method of claim 1, further comprising using a pressure-driven separation apparatus as a pre-treatment or post-treatment to change the composition of the drainage water or the treated water upstream or downstream from the electrically driven separation apparatus.

23. The method of claim 22, wherein the pressure-driven separation apparatus is selected from reverse osmosis, ultrafiltration, microfiltration, and nanofiltration.

24. The method of claim 22, further comprising feeding a blend of the drainage water with the water subject to the pre-treatment or post-treatment into the agricultural or industrial facility.

25. The method of claim 1, further comprising adjusting a concentration level of at least one of Ca, Mg, and NO₃⁻ via at least one of the following: (a) pressure-driven separation and then mixing, (b) addition of fertilizer, and (c) precipitation using lime.

26. The method of claim 1, further comprising adjusting the pH of the drainage water.

27. The method of claim 26, wherein the pH of the drainage water is the adjusted by at least one of the following: (a) using a bipolar electrodialysis membrane and (b) addition of an acidic or basic solution.

28. The method of claim 1, wherein monovalent cationic species are removed from the drainage water at a rate twice as great as the removal rate of monovalent anionic species in the electrically driven separation apparatus.

29. The method of claim 1, wherein monovalent cationic species are removed from the drainage water at a rate twice as great as the removal rate of divalent cationic species.

30. The method of claim 1, wherein monovalent anionic species are removed from the drainage water at a rate twice as great as the removal rate of divalent anionic species.

31. The method of claim 1, further comprising feeding a blend of the drainage water with source water into the agricultural or industrial facility.

32. The method of claim 1, wherein the drainage water is passed through at least two of the electrically driven separation apparatuses in series or in parallel.

33. The method of claim 1, wherein part of the drainage water is directly recirculated as recirculation water through the facility and the remainder of the drainage water is recirculated as treated water through the facility after passing through the electrically driven separation apparatus.

34. The method of claim 1, wherein part of the drainage water is discharged as discharge water and the remainder of the drainage water is recirculated through the facility as treated water through the facility after monovalent cations are removed.

35. The method of claim 1, wherein the method is used for an application selected from field farming, golf-course grass management, mining water management, oil and gas water management, textile dyeing, and chloroalkali industry water management.

36. The method of claim 1, further comprising adding nutrients to source water to produce the drainage water.

37. The method of claim 1, further comprising adding at least one of a chemical and a salt to treat source water and produce the drainage water.

38. The method of claim 1, wherein drainage water from a plurality of facilities is treated, wherein the facilities feed drainage water to the electrically driven separation apparatus in parallel.

39. The method of claim 1, further comprising producing the drainage water using a second electrically driven separation apparatus by a method comprising:
feeding source water through the second electrically driven separation apparatus;
applying a voltage to an anode and a cathode on opposite sides of the second electrically driven separation apparatus to produce (a) purified source water and (b) a discharge including impurities removed from the source water;
adding fertilizer to the purified source water to produce nutrient water; and
delivering the nutrient water to the facility to fertilize crops and produce the drainage water.
